(19) United States
(12) Patent Application Publication
(10) Pub. No.: US 2013/0256413 A1
(43) Pub. Date: Oct. 3, 2013

(54) READING AN RFID TAG ASSOCIATED WITH A REAR CONNECTOR VIA AN ELECTROMAGNETIC LOOP INDUCTION SYSTEM

(71) Applicant: TYCO ELECTRONICS UK LTD, Wiltshire (GB)

(72) Inventors: Ian Miles Standish, Flintshire (GB); Stephen Lambourn, Wiltshire (GB)

(73) Assignee: Tyco Electronics UK Ltd, Wiltshire (GB)

(21) Appl. No.: 13/850,580

(22) Filed: Mar. 26, 2013

Related U.S. Application Data
(60) Provisional application No. 61/618,111, filed on Mar. 30, 2012.
(60) Provisional application No. 61/618,200, filed on Mar. 30, 2012.

(51) Int. Cl. G06K 7/10

(52) U.S. Cl. CPC G06K 7/10415
USPC 235/439

(57) ABSTRACT

One embodiment is directed to a patching system. The patching system comprises at least one port, the port having a first side and a second side. The patching system further comprises at least one coupling circuit. The coupling circuit comprises a pickup portion and a reader portion coupled to the pickup portion. The coupling circuit is configured so that the pickup portion is positioned near the second side of the port and the reader portion is positioned near the first side of the port. The coupling circuit is configured so that an RFID tag mounted to a cable attached to the second side of the port can be read from the first side of the port via the reader portion of the coupling circuit.

### CROSS-REFERENCE TO RELATED APPLICATION

This application claims the benefit of U.S. Provisional Patent Application Ser. No. 61/618,200, filed on Mar. 30, 2012, and U.S. Provisional Patent Application Ser. No. 61/618,111, filed on Mar. 30, 2012, both of which are hereby incorporated herein by reference.

### BACKGROUND

Patching systems are commonly used in communication networks in order to provide flexibility in implementing communication links. One example of a patching system is a patch panel. A patch panel typically includes a panel in which a plurality of ports are formed or otherwise housed. Each port includes a “front” connector and a “rear” connector (or other attachment mechanism such as a punch-down block or permanently attached optical fiber pigtail). The port is configured to communicatively couple any cable attached to the front connector of that port to any cable that is attached to the rear of that port. Other patching systems are implemented in similar ways.

Many types of physical layer management (PLM) systems have been developed in order to keep track of which cables are attached to which ports of a patching system. In one type of system, each connector that is attached to a front connector of a patch panel has a radio frequency identification (RFID) tag attached to it. An RFID reader can then be used to wirelessly read an identifier from each connector's RFID tag in order to keep track of what connectors and cables are attached to the front connectors of the patch panel.

However, such conventional RFID PLM systems are often not suitable for use with high density patching systems. Moreover, conventional RFID PLM systems are typically not used to read RFID tags attached to connectors attached to the rear of the ports of a patching system.

### SUMMARY

One embodiment is directed to a patching system. The patching system comprises at least one port, the port having a first side and a second side. The patching system further comprises at least one coupling circuit. The coupling circuit comprises a pickup portion and a reader portion coupled to the pickup portion. The coupling circuit is configured so that the pickup portion is positioned near the second side of the port and the reader portion is positioned near the first side of the port. The coupling circuit is configured so that an RFID tag mounted to a cable attached to the second side of the port can be read from the first side of the port via the reader portion of the coupling circuit.

Another embodiment is directed to a method performed at a port comprising a first side and a second side. The method comprises attaching a cable to the second side of the port. The cable has an RFID tag mounted to the cable. A coupling circuit is configured so that a first portion of the coupling circuit is positioned near the first side of the port and a second portion is positioned near the second side of the port. The method further comprises coupling the second portion of the coupling circuit to the first portion of the coupling circuit and reading the RFID tag mounted to the cable that is attached to the second side of the port from the first side of the port via the second portion of the coupling circuit.

### DRAWINGS

FIG. 1 is a block diagram of one exemplary embodiment of a physical layer management system.

FIG. 2 illustrates one example of a coupling circuit suitable for use in the system of FIG. 1.

FIG. 3 is a circuit diagram of one example of a coupling circuit suitable for use in the system of FIG. 1.

FIG. 4 is a circuit diagram of one example of a loop to couple the coupling circuit of FIG. 3 to an RFID tag mounted to a connector.

FIG. 5 is a circuit diagram illustrating how the coupling circuit for FIG. 3 can be used to read an RFID tag mounted to an adapter.

### DETAILED DESCRIPTION

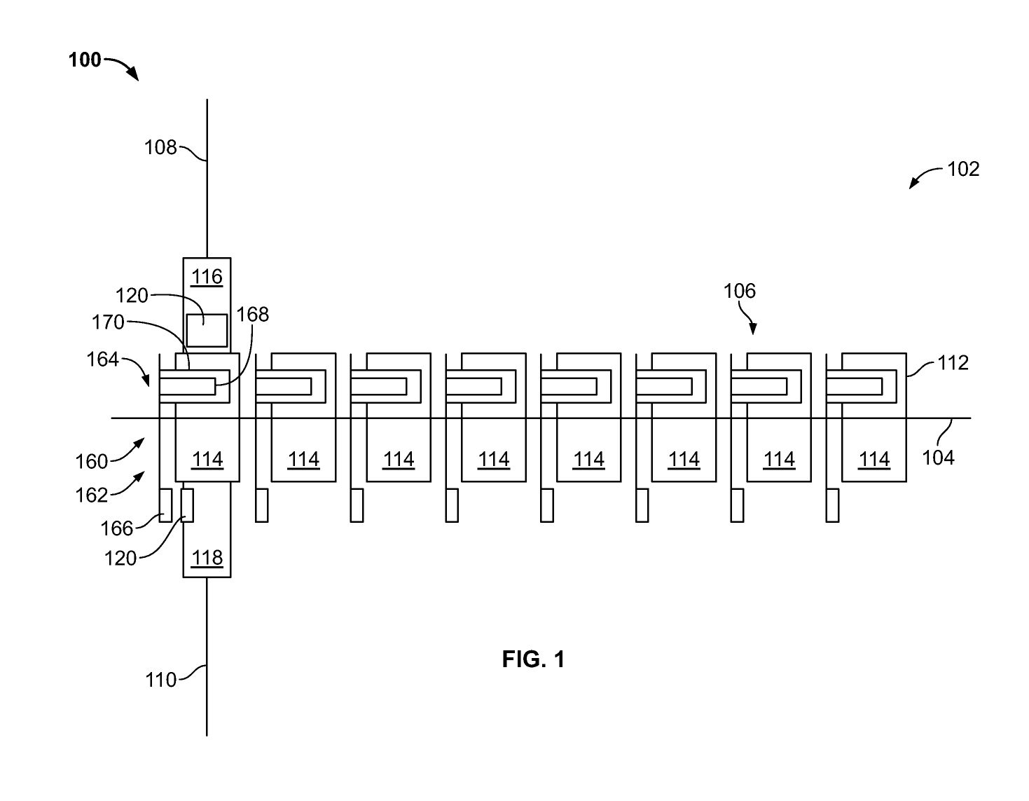

FIG. 1 is a block diagram of one exemplary embodiment of a physical layer management (PLM) system 100. The PLM system 100 comprises a patching system 102.

The patching system 102 comprises at least one panel 104 that supports a plurality of ports 106. Each port 106 is configured to communicatively couple a respective first cable 108 to a respective second cable 110 so that one or more information bearing signals can be communicated between that first cable 108 and that second cable 110.

Each port 106 comprises a respective first connector or other attachment mechanism 112 that is mounted to (or otherwise positioned on or near) the panel 104 so that a respective first cable 108 can be physically attached to a first side of that port 106. Each port 106 comprises a respective second connector or other attachment mechanism 114 that is mounted to (or otherwise positioned on or near) the panel 104 so that a respective second cable 110 can be physically attached to a second side of that port 106.

In the exemplary embodiment shown in FIG. 1, the first side of the port 106 is a “front” side of the port 106, and the first cable 108 and first connector or other attachment mechanism 112 are also referred to here as the “front” cable 108 and the “front” connector or other attachment mechanism 112. Also, in the exemplary embodiment shown in FIG. 1, the second side of the port 106 is a “rear” side of the port 106, and the second cable 110 and second connector or other attachment mechanism 114 are also referred to here as the “rear” cable 110 and the “rear” connector or other attachment mechanism 114. However, it is to be understood that other embodiments can be implemented in other ways. In particular, it is to be understood that the references to “front” and “rear” are for ease of explanation and that the techniques described here can be used with either side of a patch panel or other equipment.

In the exemplary embodiment shown in FIG. 1, each port 106 is implemented using a fiber adapter and is also referred to here as a “fiber adapter 106”. In this exemplary embodiment, the front connector or other attachment mechanism 112 in each fiber adapter 106 comprises a front optical jack (for example, an LC jack) and is also referred to here as a “front optical jack 112”. Likewise, the rear connector or other attachment mechanism 114 in each fiber adapter 106 comprises a rear optical jack (for example, an LC jack) and is also referred to here as a “rear optical jack 114”.

In this exemplary embodiment, each front cable 108 is implemented using a respective front optical cable and is also referred to here as the “front optical cable 108”. In this exemplary embodiment, each front optical cable 108 is terminated using a respective front optical cable connector 116 (for example, an LC connector) that is configured to be connected to the particular front optical jacks 112 used in the fiber adapters 106. Likewise, each rear optical cable 110 is terminated using a respective rear optical cable connector 118 (for example, an LC connector) that is configured to be connected to the particular rear optical jacks 114 used in the fiber adapters 106.

It is to be understood, however, that the ports 106 can be implemented in other ways. For example, the ports 106 can be implemented using other types of fiber adapters, the ports 106 can be implemented to connect other types of cables (for example, to electrically connect copper front and rear cables 108 and 110), and/or can be implemented so that the front connector or other attachment mechanism 112 or the rear connector or other attachment mechanism 114 is implemented using a non-connectorized attachment mechanism (for example, in the case of copper cables, using a punch-down block to which a rear cable 110 can be attached or, in the case of optical fibers, by using a fiber adapter that is manufactured with an optical pigtail permanently attached to the rear of it).

In the exemplary embodiment shown in FIG. 1, each front cable connector 116 and each rear cable connector 118 (or the associated front or rear optical cable 108 or 110) has a respective RFID tag 120 attached to or otherwise associated with it. For example, each RFID tag 120 can be attached to the cable connector 116 or 118 (or the associated front or rear optical cable 108 or 110) using a heat-shrink label or tubing, tape, or adhesive. The RFID tag 120 can also be integrated into the cable connector 116 or 118 (or the associated front or rear optical cable 108 or 110).

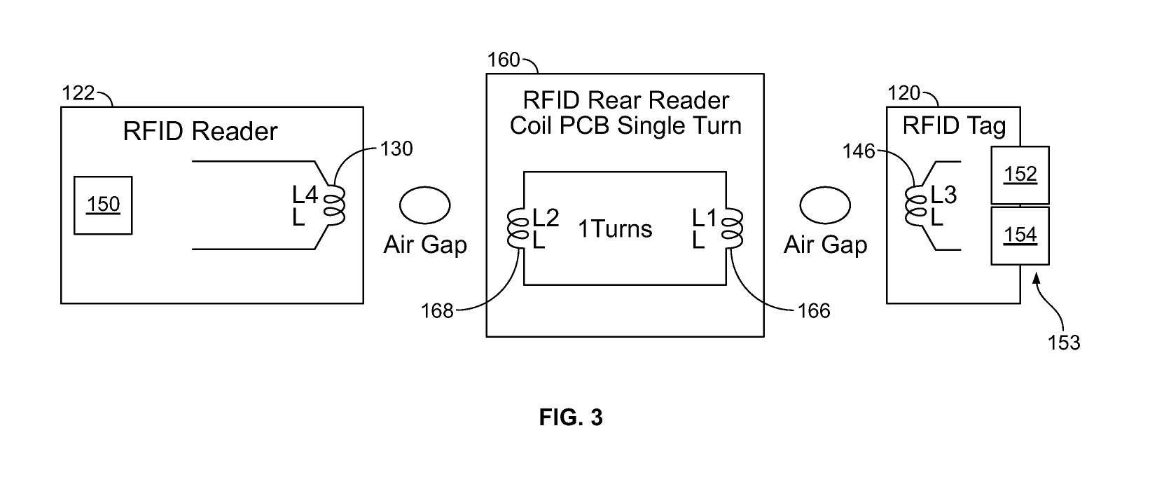

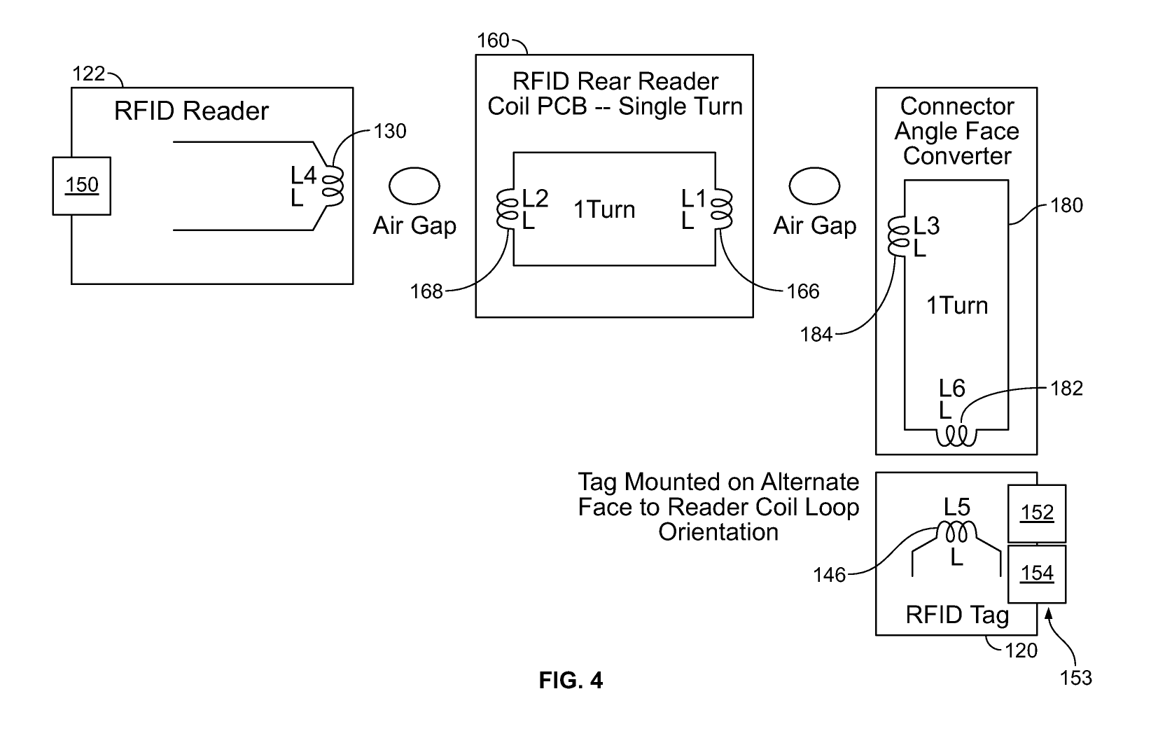

Each RFID tag 120 stores a unique identifier for the associated connector 116 or 118 and/or cable 108 or 110. This identifier can be used to identify which cable 108 or 110 is attached to each port 106 of the patch panel 102. In some implementations, the RFID tags 120 are used to store other information and/or are written to as well as read from. Typically, each RFID tag 120 includes a non-volatile memory 154 (shown in FIGS. 3 and 4) that is used to store such information and RFID transponder electronics 153 (shown in FIGS. 3 and 4) to enable the RFID tag 120 to be energized by, and communicate with, an RFID reader.

In the exemplary embodiment described here in connection with FIG. 1, the information stored in the RFID tags 120 is read using an RFID reader 122 (shown in FIGS. 3 and 4). In this embodiment, the RFID reader 122 is implemented using an RFID reader pen (and the RFID reader 122 is also referred here as the “RFID reader pen 122”), though it is to be understood that the RFID reader 122 need not be implemented using an RFID reader pen and can be implemented using other types of RFID readers including, for example, other types of handheld RFID readers. In this exemplary embodiment, the RFID reader pen 122 can be implemented using a standard commercially available RFID reader pen 122.

The RFID reader pen 122 includes standard RFID reader electronics 150 for interrogating an RFID tag 120. More specifically, the RFID reader 122 is configured to broadest a radio frequency (RF) signal that is suitable to energize an RFID tag 120 and, in response, cause the RFID tag 120 to transmit at least some of the information stored in it. In the exemplary embodiment shown in FIGS. 1-4, the RFID reader pen 122 is communicatively coupled to a handheld computer, smartphone, portable computer, or the like (using, for example, a wired connection or wireless connection such as a BLUETOOTH connection).

An RFID reader pen 122 that is outfitted with an extender can also be used to read RFID tags 120. Examples of such extenders are described in the U.S. Provisional Patent Application Ser. No. 61/618,111, filed on 30 Mar. 2012, titled “RFID PEN EXTENDER”, and having Attorney Docket No. 100.1236USPR/TO-00520, and U.S. patent application Ser. No. ______, filed on even date herewith, titled “RFID READER EXTENDER”, and having Attorney Docket No. 100.1236US01/TO-00520, both of which are incorporated by reference herein and which are collectively referred to here as the “RFID READER EXTENDER Applications”. As described in the aforementioned RFID READER EXTENDER Applications, by attaching an extender to the RFID reader pen 122, the RFID reader pen 122 can be used to more easily position the tip of the extender near an RFID tag 120 mounted on a connector that is inserted into a fiber adapter 106 (though the RFID reader pen need not include such an extender).

The information that is read from the RFID tags 120 can then be used for various PLM-related purposes. For example, the information read from the RFID tags 120 can be communicated to a central management system that tracks which cables are attached to the patch panel 102. Also, the information read from RFID tags 120 can be used in assisting a technician in moving, adding, or otherwise changing a connection that is made at the patch panel 102. For example, the information that is read form the RFID tags 120 can be used by the central management system and/or the handheld computer in connection with guiding a technician in carrying out a work order by visually signally which ports are to be affected by a particular step in the work order using LEDs included in the patch panel 102. Also, the information read from the RFID tags 120 can be used to assist in determining whether each step in the work order was properly carried out. The information read form the RFID tags 120 can be used for other purposes as well.

In some situations, it may be difficult to access the rear of the patch panel 102 in order to read RFID tags 120 attached to the rear cable connectors 118 or rear cables 110 (even using an RFID reader pen 122 that is outfitted with the extender described in the RFID PEN EXTENDER Applications).

In order to facilitate the reading of RFID tags 120 attached to the rear cable connectors 118 or rear cables 110, in the embodiment described here in connection with FIGS. 1-4, each port 106 has a circuit 160 that is configured to couple an RFID reader pen 122 positioned near the front of the port 106 to an RFID tag 120 attached to the rear cable connector 118 or rear cable 110. The circuit 160 can be implemented, for example, using a printed circuit board (PCB) or a printed foil system.

In the following description of the exemplary embodiment shown FIGS. 1-3, the circuit 160 is described as being mounted to a PCB. However, it is to be understood that this is only one example of how the circuit 160 (and the components thereof) can be mounted to the panel 104 and that the circuit 160 (and the components thereof) can be mounted to the panel 104 in other ways. For example, the circuit 160 (and the components thereof) can be mounted or otherwise implemented in or on a structure formed from a light pipe material. In such an example, this light-pipe-material structure can be illuminated by a light emitting diode (LED) or other light source included on or near that structure. This can be done in order to provide a visual indicator for the associated port 106. Such an approach can eliminate the need to form a hole for each port 106 in the front of the panel 104 in order for such LEDs to be visible. Thus, such a structure can serve a dual role—mounting the circuit 160 (and the components thereof) to the panel 104 and acting as a visible indicator.

The circuit 160 for each port 106 extends across the panel 104 so that a rear portion 162 of the circuit 160 is positioned near the rear of that port 106 and a front portion 164 of the circuit 160 is positioned near the front of that port 106.

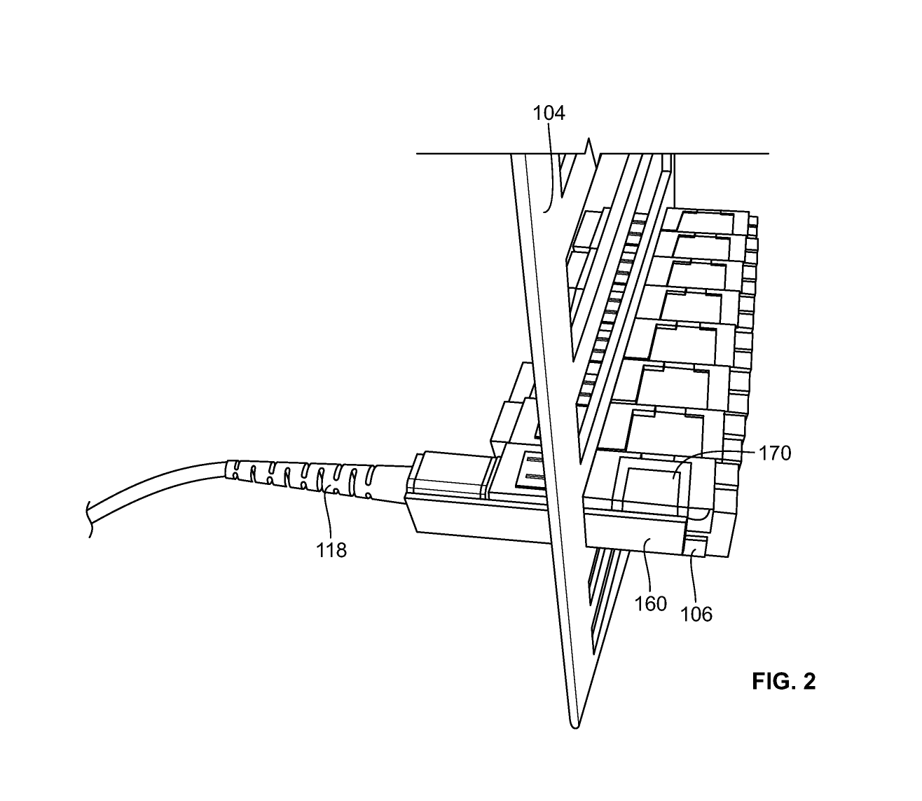

One example is shown in FIG. 2. In the example shown in FIG. 2, the opening through which each fiber adapter 106 passes is enlarged laterally. This permits the PCB on which a respective circuit 160 is mounted to be inserted into the opening on its narrow edge and positioned next to a lateral side of the fiber adapter 106.

In the example shown in FIG. 2, an RFID tag 120 (not visible) is attached to the rear optical cable connector 118 (for example, using heat-shrink tubing or using other mechanisms such as glue, overmoulding, plastic retainer, etc.). The RFID tag 120 is located on the side of the rear optical cable connector 118 near the associated PCB.

As shown in FIG. 3, the circuit 160 includes a pickup coil or other coupling element or structure 166 in the rear portion 162 of the circuit 160. The pickup coil or other coupling element or structure 166 is mounted so that at least a portion of the pickup coil or other coupling element or structure 166 is located near the rear RFID tag 120 attached to any rear optical cable connector 118 inserted into the rear of the associated fiber adapter 106. The circuit 160 also comprises a reader coil other coupling element or structure 168 in a front portion 164 of the circuit 160 in order to provide a point at which an RFID reader pen 122 can be positioned from the front of the patch panel 102 in order to interrogate the associated rear RFID tag 120. The circuit 160 electrically couples the pickup coil or other coupling element or structure 166 and the reader coil other coupling element or structure 168.

Although the term “coil” is used here in connection with the exemplary embodiment shown in FIGS. 1-4 for ease of explanation, it is to be understood that any suitable coupling element or structure can be used. In the exemplary embodiment shown in FIGS. 1-4, the pickup coil 166 and reader coil 168, for example, are both implemented using a single loop of a conductor (such as a copper or aluminum wire or stamped metal)—that is, both the pickup coil 166 and the reader coil 168 are implemented using different portions of the same loop. However, as noted above, the reader and pickup functions of the circuit 160 can be implemented in other ways, for example, using respective true coils coupled in parallel at either end of the circuit 160. Such coils can be implemented for example, using respective wire coils, respective PCB spirals, respective PCB rectangular coils, etc. Moreover, the reader and pickup coils or other coupling elements or structures 166 and 168 need not both be implemented the same way. Other coupling elements or structures can also be used.

As shown in FIG. 2, in the exemplary embodiment shown in FIGS. 1-4, the pickup coil 166 is mounted on the major surface of the rear of the PCB next to the side of any rear cable connector 118 inserted into the rear of the associated fiber adapter 106. A portion of the reader coil 168, in the example shown in FIG. 2, is mounted to a patch 170 that is affixed to the major surface of the front of the PCB. The patch 170 (with the portion of the reader coil 168 affixed to it) is flexible and bent over the top of the front of the fiber adapter 106 at a right angle. This provides a point at which an RFID reader 122 can be positioned from the front of the patch panel 102 in order to interrogate the associated rear RFID tag 120 via the circuit 160. In this way, the rear RFID tag 120 can be more conveniently read.

In this example, the single coil circuit 160 is un-tuned and freely resonant. The inherent coupling factor is achieved in this example by having the field associated with the RFID tag 120 and the RFID reader pen 122 being inside the inner edge of the pickup coil 166 and the reader coil 168, respectively.

FIG. 3 is a circuit schematic for the example circuit 160 shown in FIG. 2.

In operation, the RFID reader pen 122 can be used to interrogate a rear RFID tag 120 mounted to a rear optical cable connector 118 inserted into the rear of a fiber adapter 106. The tip of the RFID reader pen 122 is positioned on or near the patch 170 on which the reader coil 168 is mounted. The RFID reader pen 122 can then be used to interrogate the rear RFID tag 120 by causing an RFID transceiver 150 (shown in FIG. 3) in the RFID reader 122 to generate an RF signal at a predetermined RF signal (for example, by pressing a button included in the RF reader pen 122 for that purpose). The RF signal is radiated from a coil 130 (shown in FIG. 3) in the tip of the RFID reader pen 122. This RF signal induces an RF signal in the reader coil 168, which is coupled via the circuit 160 to the pickup coil 166 positioned near the rear of the fiber adapter 106. As a result, the RF signal is radiated from the pickup coil 166. This RF signal induces an RF signal in the coil 146 (shown in FIG. 3) in the RFID tag 120, which energizes the RFID tag 120. An RFID transceiver 152 (shown in FIG. 3) in the RFID tag 120 then decodes the RFID interrogation signal.

In this example, this RF signal transmitted by the RFID reader pen 122 is encoded with data indicating that any RFID tag 120 receiving that signal should read at least some of the information stored in the non-volatile memory 154 (shown in FIG. 3) included in that rear RFID tag 120 and transmit an RF signal that is encoded with at least some of the information read from the non-volatile memory 154. The RF signal transmitted by the RFID tag 120 is radiated from the coil 146 in the RFID tag 120. This RF signal induces an RF signal in the pickup coil 166, which is coupled via the circuit 160 to the reader coil 168. As a result, the RF signal is radiated from the reader coil 168. This RF signal induces an RF signal in the coil 130 in the RFID reader pen 122. The RFID transceiver 150 in the RFID reader pen 122 then decodes the RF signal to extract the information read from the non-volatile memory 154 in the RFID tag 120.

In the example shown in FIG. 2, the rear RFID tag 120 is mounted on the side of the rear optical cable connector 118. However, in some applications, the rear RFID tag 120 is mounted somewhere other than on the side of the rear optical cable connector 118 next to the pickup coil 166 such that the coil 146 in the RFID tag 120 is not positioned sufficiently close to the pickup coil 166. For example, in some applications, the rear RFID tag 120 is mounted on the top of the rear optical cable connector 118.

FIG. 4 is a circuit schematic that illustrates one example of a loop 180 that can be used to compensate for this. The loop 180 is mounted on the rear optical connector 118. The loop 180 includes a first coil 182 that is positioned near the coil 146 in the RFID tag 120 (on the face where the RFID tag 120 is mounted). The loop 180 includes a second coil 184 that is positioned on the side of the rear optical cable connector 118 so that it will be positioned near the pickup coil 166 when the connector is inserted into the rear of the fiber port adapter 106.

In the example shown in FIG. 4, there are 4 air lossy air interfaces and two mismatched free-resonant coil loops, resulting in a change to readability, which is reduced as compared to the example shown in FIG. 3 which includes only two air interfaces.

Although the RFID reader pen 122 is described here in connection with the embodiment shown in FIGS. 1-4 as including the RFID transceiver 150, it is to be understood that the RFID reader pen 122 itself need not include the RFID transceiver 150. For example, the RFID transceiver 150 can be housed within a separate unit to which the RFID reader pen 122 is communicatively coupled.

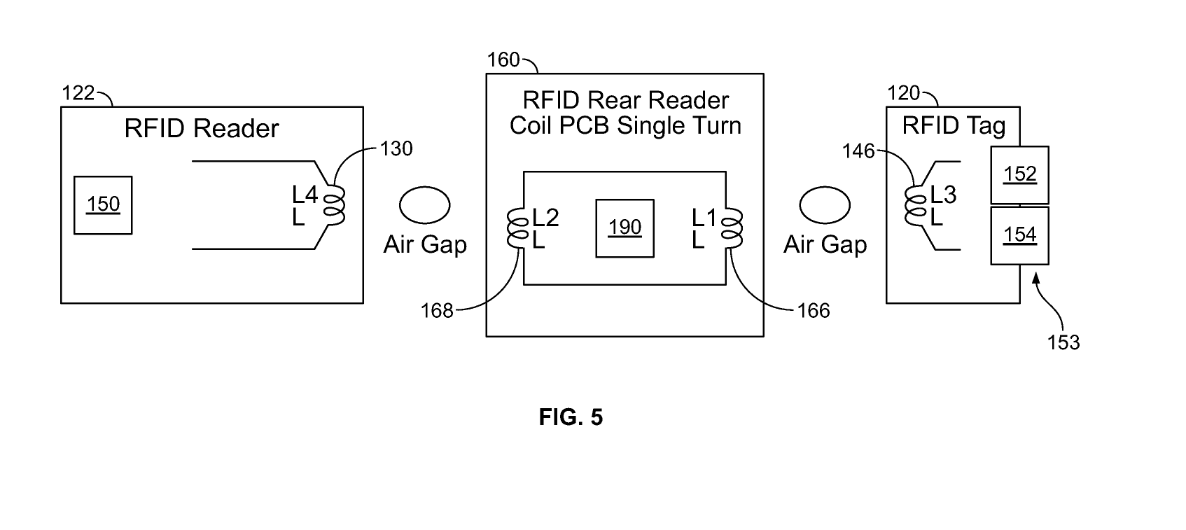

Each circuit 160 can also be used to read a RFID tag 190 that is used to identify the associated fiber adapter 106. Each RFID tag 190 is also referred to here as an “adapter” RFID tag 190. Each adapter RFID tag 190 is mounted so that it is positioned so that it can be read using the corresponding circuit 160. For example, as shown in FIG. 5, each adapter RFID tag 190 can be mounted so that it is positioned within in the main loop formed by the corresponding circuit 160. In this way, the circuit 160 can be used to read an RFID tag 120 mounted to a rear cable connector 118 and an RFID tag 190 attached to the associated fiber adapter 106. Any scheme or technology that enables multiple RFID tags to be read using the same reader can be used. For example, RFID anti-collision protocols can be used in such an example. Alternatively, RFID components that enable the fast reading of multiple RFID tags at the same time can be used in order to avoid the delays associated with the use of anti-collision algorithms.

As noted above, although the preceding examples have been described above in connection with optical connectors and adapters, one of ordinary skill in the art can recognize that the techniques described here can be used with other types of communication media, such as copper communication media, connectors, and jacks and plugs.

For example, in the embodiments described above, the RFID reader is implemented using an RFID reader pen. However, as noted above, the RFID reader need not be implemented using an RFID reader pen and can be implemented using other types of RFID readers including, for example, other types of handheld RFID readers.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes a patching system comprising: at least one port, the port having a first side and a second side; at least one coupling circuit, wherein the coupling circuit comprises a pickup portion and a reader portion coupled to the pickup portion; wherein the coupling circuit is configured so that the pickup portion is positioned near the second side of the port and the reader portion is positioned near the first side of the port; wherein the coupling circuit is configured so that an RFID tag mounted to a cable attached to the second side of the port can be read from the first side of the port via the reader portion of the coupling circuit.

Example 2 includes the system of Example 1, wherein the pickup portion of the coupling circuit comprises at least one of: a pickup coil, a coupling element, and a coupling structure; and wherein the reader portion of the coupling circuit comprises at least one of: a reader coil, a coupling element, and a coupling structure.

Example 3 includes the system of any of the Examples 1-2, wherein the pickup portion of the coupling circuit and the reader portion of the coupling circuit are both implemented using a single loop.

Example 4 includes the system of any of the Examples 1-3, wherein the pickup portion of the coupling circuit and the reader portion of the coupling circuit are each implemented using at least one of a wire coil, a printed circuit board (PCB) spiral, and a PCB rectangular coil.

Example 5 includes the system of any of the Examples 1-4, wherein the RFID tag mounted to the cable attached to the second side of the port comprises a connector to which the RFID tag is attached.

Example 6 includes the system of Example 5, wherein the RFID tag is attached to the connector so that the RFID tag is positioned near at least a portion of the coupling circuit when the connector is attached to the second side of the port.

Example 7 includes the system of any of the Examples 5-6, wherein a loop is attached to the connector so that at least a portion of the loop is positioned near at least a portion of the coupling circuit when the connector is attached to the second side of the port, wherein the loop is configured to couple the RFID tag to the coupling circuit.

Example 8 includes the system of any of the Examples 1-7, wherein the coupling circuit is mounted to a printed circuit board.

Example 9 includes the system of any of the Examples 1-8, wherein the coupling circuit is mounted to a structure implemented using a light-pipe material that is also used as a visual indicator for the port.

Example 10 includes the system of any of the Examples 1-9, wherein the port comprises a fiber adapter.

Example 11 includes the system of Example 10, wherein the fiber adapter has an adapter RFID tag mounted to the fiber adapter; and wherein the coupling circuit is configured to read the adapter RFID tag mounted to the fiber adapter.

Example 12 includes the system of any of the Examples 1-11, further comprising a panel configured to hold a plurality of ports.

Example 13 includes a method performed at a port comprising a first side and a second side, the method comprising: attaching a cable to the second side of the port, wherein the cable has an RFID tag mounted to the cable, wherein a coupling circuit is configured so that a first portion of the coupling circuit is positioned near the first side of the port and a second portion is positioned near the second side of the port; coupling the second portion of the coupling circuit to the first portion of the coupling circuit; and reading the RFID tag mounted to the cable that is attached to the second side of the port from the first side of the port via the second portion of the coupling circuit.

Example 14 includes the method of Example 13, wherein the RFID tag mounted to the cable attached to the second side of the port comprises a connector to which the RFID tag is attached.

Example 15 includes the method of Example 14, wherein the RFID tag is attached to the connector so that the RFID tag is positioned near at least a portion of the coupling circuit when the connector is attached to the second side of the port.

Example 16 includes the method of any of the Examples 14-15, wherein a loop is attached to the connector so that at least a portion of the loop is positioned near at least a portion of the coupling circuit when the connector is attached to the second side of the port; wherein reading the RFID tag mounted to the cable that is attached to the second side of the port comprises reading the RFID tag mounted to the cable that is attached to the second side of the port from the first side of the port via the second portion of the coupling circuit and the loop attached to the connector.

Example 17 includes the method of any of the Examples 13-16, wherein the coupling circuit is mounted to a printed circuit board.

Example 18 includes the method of any of the Examples 13-18, wherein the coupling circuit is mounted to a structure implemented using a light-pipe material; and wherein the method further comprises providing a visual indicator using the light-pipe material.

Example 19 includes the method of any of the Examples 13-18, wherein the port comprises a fiber adapter.

Example 20 includes the method of Example 19, wherein the fiber adapter has an adapter RFID tag mounted to the fiber adapter; and wherein the method further comprises: reading the adapter RFID tag mounted to the fiber adapter using the coupling circuit.

What is claimed:

1. A patching system comprising:
at least one port, the port having a first side and a second side;
at least one coupling circuit, wherein the coupling circuit comprises a pickup portion and a reader portion coupled to the pickup portion;
wherein the coupling circuit is configured so that the pickup portion is positioned near the second side of the port and the reader portion is positioned near the first side of the port;
wherein the coupling circuit is configured so that an RFID tag mounted to a cable attached to the second side of the port can be read from the first side of the port via the reader portion of the coupling circuit.

2. The system of claim 1, wherein the pickup portion of the coupling circuit comprises at least one of: a pickup coil, a coupling element, and a coupling structure; and
wherein the reader portion of the coupling circuit comprises at least one of: a reader coil, a coupling element, and a coupling structure.

3. The system of claim 1, wherein the pickup portion of the coupling circuit and the reader portion of the coupling circuit are both implemented using a single loop.

4. The system of claim 1, wherein the pickup portion of the coupling circuit and the reader portion of the coupling circuit are each implemented using at least one of a wire coil, a printed circuit board (PCB) spiral, and a PCB rectangular coil.

5. The system of claim 1, wherein the RFID tag mounted to the cable attached to the second side of the port comprises a connector to which the RFID tag is attached.

6. The system of claim 5, wherein the RFID tag is attached to the connector so that the RFID tag is positioned near at least a portion of the coupling circuit when the connector is attached to the second side of the port.

7. The system of claim 5, wherein a loop is attached to the connector so that at least a portion of the loop is positioned near at least a portion of the coupling circuit when the connector is attached to the second side of the port, wherein the loop is configured to couple the RFID tag to the coupling circuit.

8. The system of claim 1, wherein the coupling circuit is mounted to a printed circuit board.

9. The system of claim 1, wherein the coupling circuit is mounted to a structure implemented using a light-pipe material that is also used as a visual indicator for the port.

10. The system of claim 1, wherein the port comprises a fiber adapter.

11. The system of claim 10, wherein the fiber adapter has an adapter RFID tag mounted to the fiber adapter; and
wherein the coupling circuit is configured to read the adapter RFID tag mounted to the fiber adapter.

12. The system of claim 1, further comprising a panel configured to hold a plurality of ports.

13. A method performed at a port comprising a first side and a second side, the method comprising:
attaching a cable to the second side of the port, wherein the cable has an RFID tag mounted to the cable, wherein a coupling circuit is configured so that a first portion of the coupling circuit is positioned near the first side of the port and a second portion is positioned near the second side of the port;
coupling the second portion of the coupling circuit to the first portion of the coupling circuit; and
reading the RFID tag mounted to the cable that is attached to the second side of the port from the first side of the port via the second portion of the coupling circuit.

14. The method of claim 13, wherein the RFID tag mounted to the cable attached to the second side of the port comprises a connector to which the RFID tag is attached.

15. The method of claim 14, wherein the RFID tag is attached to the connector so that the RFID tag is positioned near at least a portion of the coupling circuit when the connector is attached to the second side of the port.

16. The method of claim 14, wherein a loop is attached to the connector so that at least a portion of the loop is positioned near at least a portion of the coupling circuit when the connector is attached to the second side of the port;
wherein reading the RFID tag mounted to the cable that is attached to the second side of the port comprises reading the RFID tag mounted to the cable that is attached to the second side of the port from the first side of the port via the second portion of the coupling circuit and the loop attached to the connector.

17. The method of claim 13, wherein the coupling circuit is mounted to a printed circuit board.

18. The method of claim 13, wherein the coupling circuit is mounted to a structure implemented using a light-pipe material; and
wherein the method further comprises providing a visual indicator using the light-pipe material.

19. The method of claim 13, wherein the port comprises a fiber adapter.

20. The method of claim 19, wherein the fiber adapter has an adapter RFID tag mounted to the fiber adapter; and
wherein the method further comprises: reading the adapter RFID tag mounted to the fiber adapter using the coupling circuit.
